(19) United States
(12) Patent Application Publication
(10) Pub. No.: US 2001/0033134 A1
(43) Pub. Date: Oct. 25, 2001

(54) High intensity discharge (HID) lamp with integral ballast and underwater lighting systems incorporating same

(76) Inventor: Carl Saieva, Port Jefferson, NY (US)

Correspondence Address: Thomas M. Galgano, Esq., Galgano & Burke, Suite 135, 300 Rabro Drive, Hauppauge, NY, 11788, US

(21) Appl. No.: 09/783,767

(22) Filed: Feb. 15, 2001

Related U.S. Application Data
(60) Provisional application No. 60/183,767, filed on Feb. 18, 2000.

(51) Int. Cl. H01J 1/62

(52) U.S. Cl. 313/491

(57) ABSTRACT

A portable battery powered high intensity lighting system that produces solar quality illumination at four to six times the efficiency of comparable incandescent lighting systems includes a light head and a power source. The light head contains an HID (high intensity discharge) arc lamp. A sealed enclosure containing a ballast is attached immediately adjacent to the lamp assembly. The ballast enclosure is preferably potted with a thermally conductive epoxy.

This application claims the benefit of provisional application Ser. No. 60/183,767, filed Feb. 18, 2000, the complete disclosure of which is hereby incorporated by reference herein.

### BACKGROUND OF THE INVENTION

1. Field of the Invention

The invention relates to lamps and lighting systems for use underwater by divers. More particularly, the invention relates to an HID lamp with integral ballast and underwater lighting systems incorporating the same.

2. Brief Description of the Prior Art

Underwater exploration is virtually impossible without the aid of some type of artificial lighting system. Even under broad daylight, when diving beyond a certain depth, the natural light from the sun is severely affected by the water. In addition to loss of light intensity, the water produces spectral changes in the light to the extent that color is not readily recognizable and the view underwater appears to be only bluish black and white. Moreover, even at relatively shallow depths, artificial lighting is necessary to see objects in shadows or in crevices. Exploration of caves and shipwrecks is impossible without bright artificial lighting systems.

The simplest lighting systems utilize ordinary incandescent lamps powered by rechargeable batteries. Ordinary incandescent lamps are inefficient and produce a limited spectrum which is unsuitable for photography, particularly under water. Halogen lamps provide a much higher intensity than ordinary incandescent lamps and also provide a balanced spectrum which can be used with certain types of film to accurately capture colors in underwater photographs. For example, many halogen lamps are balanced to a color temperature of 3200° K., and some film emulsions are designed to be used with illumination with this spectrum. Filters are also available for use with daylight (6500° K.) balanced emulsions and 3200° K. light sources.

Although the halogen lamps are an improvement over ordinary incandescent lamps, they share some of the disadvantages of ordinary incandescent lamps and have some disadvantages of their own. Both kinds of lamps rely on the heating of a filament by an electric current passing through the filament. In order to produce more light output and a higher color temperature, more current must be provided to the filament. This requires either a larger battery or results in a shorter “burn life”. Since divers are burdened with enough equipment to begin with, a large battery pack is certainly undesirable. Filament lamps also have the disadvantage that the filament is easily damaged by thermal or mechanical shock.

A new type of lamp referred to as a high intensity discharge (HID) lamp is disclosed in U.S. Pat. No. 5,144,201 (the complete disclosure of which is hereby incorporated by reference herein) and is generally available from Welch Allyn, Inc. (Skaneateles Falls, N.Y.). The lamp contains an anode and a cathode and a mixture of mercury, argon and other chemicals. The anode and the cathode are coupled to a ballast having a DC power input. When a DC voltage (9-16 VDC) is applied to the power input of the ballast, the ballast begins a start-up sequence. The ballast first produces a series of high voltage (25 KV) high frequency (33 KHZ) pulses that ionize the gases inside the lamp. During this sequence the ballast monitors the resistance of the lamp. When the gases have been sufficiently excited, an arc is struck across the anode and cathode. After the arc is struck, the ballast applies a reduced DC voltage to the anode and cathode of approximately 60 VDC. The ballast continuously monitors the resistance of the lamp and controls the current to the lamp in order to maintain the arc and prevent overdriving. The color of the light produced by the HID lamp is determined by the mix of material (compounds and/or gases) contained in the lamp and the extent to which they are excited by the continuing current. Typically, the color temperature is in the range of 4700-6500° K.

The HID lamps provided by Welch Allyn and others are not particularly designed for use under water. Many manufacturers intend that these lamps be used in automotive applications and in image projection applications such as projection television. For a variety of reasons, Welch Allyn recommends that the lamp and ballast be located apart from each other. In most applications, this does not present a problem. However, in an underwater lighting system, location of the ballast apart from the lamp can be problematic. The typical underwater lighting system includes a battery pack which is coupled by a cable to a hand-held lamp assembly. If the ballast is not located adjacent to the lamp assembly, it must be located adjacent to the battery pack. The battery pack is typically strapped to the diver's torso, arm or leg. In order for the lamp assembly to be freely positionable, the cable connecting the lamp assembly to the battery pack must be sufficiently long. It has been discovered, however, that if the cable length from the ballast to the lamp assembly is more than approximately 18 inches, the lamp may not reliably startup.

### SUMMARY OF THE INVENTION

It is therefore an object of the invention to provide a lamp for an underwater lighting system and an underwater lighting system incorporating the same.

It is also an object of the invention to provide a lamp for an underwater lighting system which has a high color temperature.

It is another object of the invention to provide a lamp for an underwater lighting system which is energy efficient.

It is yet another object of the invention to provide a lamp for an underwater lighting system which can be coupled to a battery pack via a relatively long cable or integrated into single hand-held unit composed of a lamp, ballast and battery.

It is another object of the invention to provide underwater lighting systems incorporating the lamp described above.

In accord with these objects, which will be discussed in detail below, the lamp according to the invention includes an hermetically sealed quartz glass envelope containing an anode, a cathode, and mixture of ionizable elements and/or compounds. A sealed ballast container is mounted immediately adjacent to the glass envelope. A ballast is located in the sealed container and is electrically coupled to the anode and cathode. The ballast input is preferably coupled to a standard type of connector so that the lamp may be retrofitted to an existing lighting system. A lighting system according to the invention includes the lamp and ballast assembly described above, a battery pack, and a cable electrically coupling the ballast to the battery pack. Eight embodiments of the lamp and ballast assembly are provided for use with different lighting systems. One type of connector is disclosed for permanently coupling the lamp and ballast assembly to a single battery pack. Another type of connector is disclosed which permits under water swapping of battery packs.

### BRIEF DESCRIPTION OF THE DRAWINGS

FIG. 1 is a side elevation view of a first embodiment of a lamp and ballast assembly according to the invention;

FIG. 1a is an end view of the lamp and ballast assembly of FIG. 1;

FIG. 2 is a side elevation view of a second embodiment of a lamp and ballast assembly according to the invention;

FIG. 2a is an end view of the lamp and ballast assembly of FIG. 2;

FIG. 3 is a side elevation view of a third embodiment of a lamp and ballast assembly according to the invention;

FIG. 3a is an end view of the lamp and ballast assembly of FIG. 3;

FIG. 4 is a side elevation view of a fourth embodiment of a lamp and ballast assembly according to the invention;

FIG. 4a is an end view of the lamp and ballast assembly of FIG. 4;

FIG. 5 is a side elevation view of a fifth embodiment of a lamp and ballast assembly according to the invention;

FIG. 5a is an end view of the lamp and ballast assembly of FIG. 5;

FIG. 6 is a side elevation view of a sixth embodiment of a lamp and ballast assembly according to the invention;

FIG. 6a is an end view of the lamp and ballast assembly of FIG. 6;

FIG. 7 is a side elevation view of a first embodiment of a cable connector;

FIG. 8 is a side elevation view of a second embodiment of a cable connector;

FIG. 9 is a side elevation view of a socket for use with the cable connector of FIG. 8;

FIG. 9a is an end view of the socket of FIG. 9;

FIG. 10 is a perspective view of a lighting system according to the invention;

FIG. 11 is a side elevation view of a seventh embodiment of the invention showing a hand-held unit composed of a lamp ballast and battery;

FIG. 11a is an end view of the invention shown in FIG. 11;

FIG. 12 is a side elevation view of an eight embodiment of the invention in the form of a head-mount or hand-held unit composed of a lamp and ballast; and

FIG. 12a is an end view of the unit shown in FIG. 12.

### DETAILED DESCRIPTION

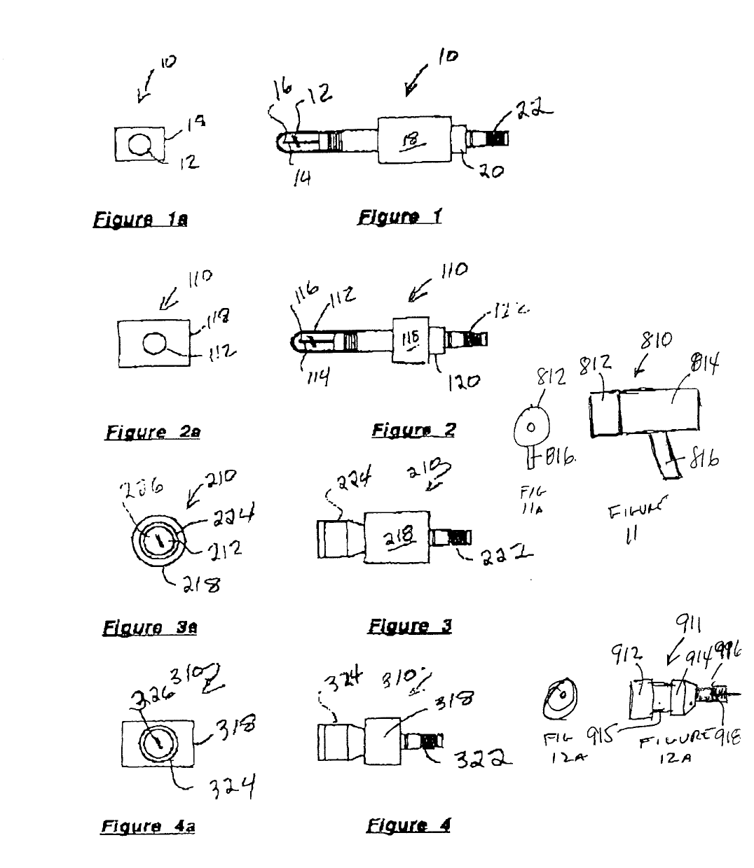

Turning now to FIGS. 1 and 1a, a lamp 10 according to the invention includes a hermetically sealed quartz glass envelope 12 containing an anode 14, a cathode 16, and mixture of ionizable elements and/or compounds (not shown). A sealed ballast container 18 is mounted immediately adjacent to the glass envelope 12. A ballast (not shown) is located in the sealed container 18 and is electrically coupled to the anode 14 and cathode 16. The ballast container 18 typically made of metal and/or plastic is preferably potted with a thermally conductive epoxy insulator and is (i.e., not electrically conductive), this serves as a heat sink to discharge heat from the unit. Alternatively, other heat sink arrangements (not shown) to dissipate heat from the ballast can be used. The ballast input 20 is preferably coupled to a standard type of connector (FIGS. 7 and 8 described below) so that the lamp 10 may be retrofitted to an existing lighting system. As shown in FIG. 1, a portion of the connector (otherwise not shown) includes a strain relief 22. As shown in Figure la, the ballast container 18 is rectangular in configuration. According to this embodiment, the lamp 10 is a 10-30 watt lamp, has an overall length of about 8 3/16 inches and a maximum width of about 2 3/16 inches.

Turning now to FIGS. 2 and 2a, a lamp 110 according to the invention is similar to the lamp 10 described above with similar reference numerals referring to similar features. According to this embodiment, the lamp 110 is a 10-30 watt lamp, has an overall length of about 6 1/16 inches and a maximum width of about 3 3/16 inches.

Turning now to FIGS. 3 and 3a, a lamp 210 according to the invention is similar to the lamp 10 described above with similar reference numerals referring to similar features. According to this embodiment, the glass envelope 212 is contained within a cylindrical protector 224 having a transparent window 226 and the ballast container 218 is also cylindrical. The lamp 210 is a 10-30 watt lamp, has an overall length of about 5 inches and a maximum diameter of about 2⅜ inches.

Turning now to FIGS. 4 and 4a, a lamp 310 according to the invention is similar to the lamp 210 described above with similar reference numerals referring to similar features. According to this embodiment, the ballast container 318 is rectilinear. The lamp 310 is a 10-30 watt lamp, has an overall length of about 5 inches and a maximum width of about 3 3/16 inches.

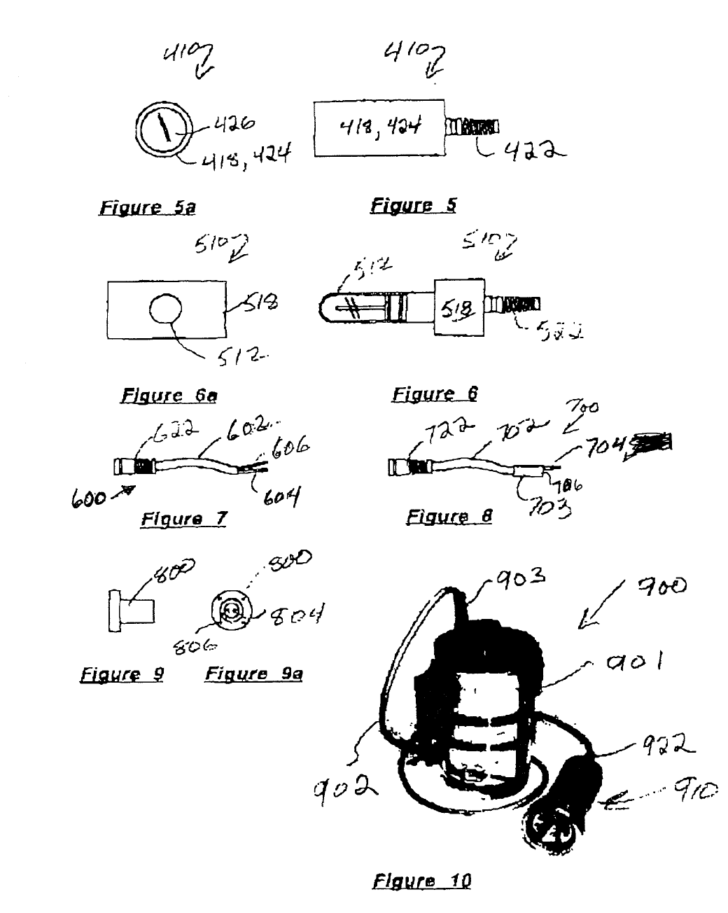

FIGS. 5 and 5a illustrate a lamp 410 which is housed in a monolithic cylinder 418, 414 having a transparent window 426 at one end. The lamp 410 is a 10-30 watt lamp, has an overall length of about 5 5/18 inches and a maximum diameter of about 2½ inches. The monolithic cylinder is preferably hermetically sealed and waterproof to a predetermined depth.

FIGS. 6 and 6a illustrate a lamp 510 which is similar to the lamps 10 and 110 described above. The lamp 510 is a 50-90 watt lamp, has an overall length of about 7.25 inches and a maximum width of about 5.187 inches.

Turning now to FIG. 7, a connector 600 according to the invention includes a cable 602 having free ends 604, 606 for relatively permanent coupling to a battery pack (not shown). The other end of the connector 600 has a strain relief 622 which is similar to the strain reliefs describe above.

FIG. 8 illustrates an alternate connector 700, which includes a cable 702 having a male/female connector 703 with a male contact 704 and a female contact 706 at one end thereof and a strain relief 722 at the other end thereof. The connector 700 is designed to be temporarily connected to a battery pack and swappable to another battery pack while under water (“wet pluggable”) using a mating connector from the battery/power pack (not shown).

FIGS. 9 & 9A illustrate an alternate connection 800 which includes male contact 84 and female contact 806. The connector 800 is designed to be temporarily connected to a battery pack and swappable to another battery pack while under water (wet pluggable) using a mating connector from the battery/power pack.

FIG. 10 illustrates a lighting system 900 according to the invention. The system 900 includes a battery pack 901 and a lamp and ballast assembly 910. The ballast in the assembly 910 is coupled by a cable 902, having a connector 903 and a strain relief 922, to the battery pack 901. The assembly 910 is hermetically sealed and waterproof to a predetermined depth.

FIG. 11 and 11a illustrate a hand-held lamp 810 which is similar to lamps 10, 110, 510 described above. The lamp 810 is composed of a 10-20 Watt HID lamp and reflector assembly 812 which is coupled to a ballast and battery pack contained in housing 814 which is provided with a handle grip 816. The assembly has an overall length of 5″ to 12″ and a width or diameter from 2″ to 6″. Both dimensions will be dependent on the battery chemistry and size used.

FIG. 12 and 12a illustrate a mini lamp 911 which is similar to lamp 10, 110, and 510 described above. The lamp 911 is composed of a 10-20 watt HID lamp and reflector assembly 912 which is coupled to a ballast contained in ballast housing 914 which, in turn, is provided with connector 916 and strain relief 918 to permit coupling to a remote battery pack (not shown). The lamp assembly has an overall length of 3¼″. The ballast housing 914 is provided with a recessed center section 915 to allow the same to be releasably attached to a head clamp (not shown). Alternatively, it could be hand held.

There have been described and illustrated herein several embodiments of a high intensity discharge (HID) lamp with integral ballast and underwater lighting systems incorporating the same. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as so claimed.

What is claimed is:

1. A high intensity discharge lamp assembly, comprising:
a) an hermetically sealed glass envelope containing a mixture of ionizable elements and/or compounds;
b) a sealed ballast container mounted adjacent to said glass envelope;
c) an electronic ballast contained in said container, said ballast having an input and an output;
d) an anode disposed in said envelope and electrically coupled to one pole of said ballast output;
e) a cathode disposed in said envelope and electrically coupled to another pole of said ballast output; and
f) coupling means for coupling said input of said ballast to a DC power source.

2. A lamp assembly according to claim 1, further comprising:
g) a waterproof protective container covering said envelope, said waterproof protective container having a transparent window.

3. A lamp assembly according to claim 1, further comprising:
g) a waterproof protective container covering said envelope and said ballast container, said waterproof protective container having a transparent window.

4. A lamp assembly according to claim 1, wherein:
said coupling means is cable with a wet pluggable plug at one end for coupling/uncoupling to/from a battery pack while under water.

5. A lamp assembly according to claim 1, wherein:
said coupling means is cable with a pair of connectors at one end for coupling to a battery pack.

6. A lamp assembly according to claim 1, wherein:
said ballast container is potted with a thermally conductive epoxy.

7. A lamp assembly according to claim 6, wherein:
said ballast container is made from a member selected from the group consisting of metal, plastic and/or a combination thereof.

8. An underwater lighting system, comprising:
a) an hermetically sealed glass envelope containing a mixture of ionizable elements and/or compounds;
b) a sealed ballast container mounted adjacent to said glass envelope;
c) an electronic ballast contained in said container, said ballast having an input and an output;
d) an anode disposed in said envelope and electrically coupled to one pole of said ballast output;
e) a cathode disposed in said envelope and electrically coupled to another pole of said ballast output;
f) a battery pack having a power coupling; and
g) a cable coupled to said input of said ballast to said power output of said battery pack.

9. An underwater lighting system according to claim 8, further comprising:
h) a waterproof protective container covering said envelope, said waterproof protective container having a transparent window.

10. An underwater lighting system according to claim 8, further comprising:
h) a waterproof protective container covering said envelope and said ballast container, said waterproof protective container having a transparent window.

11. An underwater lighting system according to claim 8, wherein:
said cable has a wet pluggable plug at one end and said power output of said battery pack has a wet pluggable socket.

12. An underwater lighting system according to claim 8, wherein:
said cable with a pair of connectors at one end permanently coupled to said power output of said battery pack.

13. An underwater lighting system according to claim 8, wherein:
said ballast container is potted with a thermally conductive epoxy.

14. An underwater lighting system according to claim 13, wherein:
said ballast container is made from a material selected from the groups of metal, plastic or a combination thereof.

15. An underwater lighting system according to claim 8, wherein
said ballast container is mounted within 18 inches of said glass envelope.
